(19) United States
(12) Patent Application Publication
(10) Pub. No.: US 2013/0286322 A1
(43) Pub. Date: Oct. 31, 2013

(54) LCD Device and Backlight Module

(71) Applicants: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(21) Appl. No.: 13/515,584

(22) PCT Filed: May 9, 2012
(86) PCT No.: PCT/CN12/75253

§ 371 Date: Jun. 13, 2012

(30) Foreign Application Priority Data
Apr. 28, 2012 (CN) 201210132610.8

(51) Int. Cl. G02F 1/1333; G09F 13/04

(52) U.S. Cl. 349/58; 362/97.2

(57) ABSTRACT

The invention relates to the field of LCDs, and more particularly to an LCD device and a backlight module. The LCD device includes a middle frame, a backplane, and an LCD panel; the LCD panel is arranged on a support surface of the middle frame; the middle frame includes a plurality of member units, and a distance is reserved between two adjacent member units. A bottom plate of the backplane is provided with protrusion(s) used for assistantly supporting the LCD panel; protrusion comprises a support surface; the support surface of the protrusion is flush with the support surface of the middle frame. The protrusions for assistantly supporting the LCD panel are additionally arranged on the LCD device of the invention, and the protrusions are arranged between two member units when the distance between two adjacent member units is long, to provide intermediate support force, so as to enable the support force obtained by the LCD panel is more uniform, and prevent excessive local stress.

### TECHNICAL FIELD

The invention relates to the field of liquid crystal displays (LCDs), and more particularly to an LCD device and a backlight module.

### BACKGROUND

A conventional LCD device generally includes a front frame, an LCD panel, a middle frame, a backlight module, a back cover and the like. The backlight module includes an optical film, a light guide panel (LGP), a lightbar and the like. The front frame, the middle frame and the back cover respectively have different functions; the front frame is mainly used for fixing the LCD panel and preventing the LCD panel from escaping, the middle frame is mainly used for bearing the LCD panel and shielding partial backlight module from light leakage, and the back cover is mainly used for bearing the optical film, the LGP, the lightbar and the like and ensuring the planeness of the backlight module.

To save cost, a part of the LCD device employs a segmented middle frame. The middle frame includes a plurality of member units; the member units are respectively fixed on the backplane or the front frame, and a distance is reserved between every two member units. The same member units are applied to the devices of various sizes; thus, the material is reduced to be used, and the development cost and cycle of LCD device are saved.

Because the middle frame is of a segmented structure, the support surface of the middle frame is also discontinuous; thus, the support force applied to the LCD panel is nonuniform. When the distance between two adjacent member units of the LCD device is long, the planeness of the LCD panel is affected to some extent, and excessive local stress is easily generated on the LCD panel. The LCD panel includes thin glass substrate(s) which is hard and fragile, and the glass substrate is easily damaged because of stress concentration, resulting in adverse effect on the quality of the whole LCD device.

### SUMMARY

In view of the above-described technical problems, the aim of the invention is to provide an LCD device and a backlight module thereof with a segmented middle frame and low cost. The LCD device and the backlight module can ensure that a support force applied to the LCD panel is uniform, and avoid excessive local stress.

A first technical scheme of the invention is that: an LCD device comprises a middle frame, a backplane, and an LCD panel; the LCD panel is arranged on a support surface of the middle frame; the middle frame comprises a plurality of member units, and a distance is reserved between two adjacent member units. A bottom plate of the backplane is provided with protrusion(s) for assistantly supporting the LCD panel; the protrusion(s) comprises a support surface, and the support surface of the protrusion is flush with the support surface of the middle frame. The backplane is locally punched to form the protrusion. Partial side walls of the protrusion are of an open structure, the protrusion is in a bent bar shape, the support surface of the protrusion is a plane, and the width of the support surface of the protrusion is less than or equal to that of the support surface of the middle frame. The member units are frame corner members, and are distributed on the four corners of the backplane. The number of the protrusions arranged between part of adjacent member units is multiple.

A second technical scheme of the invention is that: an LCD device comprises a middle frame, a backplane, and an LCD panel; the LCD panel is arranged on a support surface of the middle frame; the middle frame comprises a plurality of member units, and a distance is reserved between two adjacent member units. A bottom plate of the backplane is provided with protrusion(s) used for assistantly supporting the LCD panel; the protrusion(s) comprises a support surface; the support surface of the protrusion is flush with the support surface of the middle frame.

Preferably, the backplane is locally punched to form the protrusion; the side walls of the protrusion are of a closed structure. The protrusion does not add the material cost. The protrusion with side walls of a closed structure has high strength, and can provide higher support force.

Preferably, the backplane is locally punched to form the protrusion; partial side walls of the protrusion are of an open structure, and the protrusion is in a bent bar shape. The protrusion does not add the material cost, and the protrusion with side walls of an open structure has slightly low strength. However, the height of the protrusion can be designed to be high. When the ductibility of the material of the backplane is slightly low, and the maximum height of the protrusion with side walls of a closed structure is still not high enough to be flush with the support surface of the middle frame, under the condition of ensuring that the material does not fracture, the scheme can be employed.

Preferably, the support surface of the protrusion is a plane. The plane can better provide support for the LCD panel, to avoid the adverse effect of point contact and line contact on the LCD panel.

Preferably, the width of the support surface of the protrusion is less than or equal to that of the support surface of the middle frame, to avoid blocking out the light emitted by the backlight module.

Preferably, the member units are frame corner members, and are distributed on the four corners of the backplane.

Preferably, the member units are frame edge members, and are distributed on the four edges of the backplane.

Preferably, the member units are frame corner members and frame edge members; the frame corner members are distributed on the four corners of the backplane, and the frame edge members are distributed on the four edges of the backplane.

Preferably, the number of the protrusions between part of adjacent member units is multiple. Both the number and length of the protrusions can be purposefully set in accordance with the distance between two adjacent member units. When the distance between two adjacent member units is long, a plurality of protrusions are arranged; and when the distance between two adjacent member units is short, only one protrusion is arranged, or no protrusion is arranged.

The invention further provides a backlight module, comprising a middle frame, and a backplane; the middle frame is provided with a support surface used for supporting the LCD panel; the middle frame comprises a plurality of member units, and a distance is reserved between two adjacent member units. A bottom plate of the backplane is provided with protrusion(s) used for assistantly supporting the LCD panel; the protrusion comprises a support surface; the support surface of the protrusion is flush with the support surface of the middle frame.

Preferably, the backplane is locally punched to form the protrusion; the side walls of the protrusion are of a closed structure.

Preferably, the backplane is locally punched to form the protrusion; partial side walls of the protrusion are of an open structure, and the protrusion is in a bent bar shape.

Preferably, the support surface of the protrusion is a plane.

Preferably, the width of the support surface of the protrusion is less than or equal to that of the support surface of the middle frame.

Preferably, the member units are frame corner members, and are distributed on the four corners of the backplane.

Preferably, the member units are frame edge members, and are distributed on the four edges of the backplane.

Preferably, the member units are frame corner members and frame edge members; the frame corner members are distributed on the four corners of the backplane, and the frame edge members are distributed on the four edges of the backplane.

Preferably, the number of the protrusions arranged between part of adjacent member units is multiple.

In the invention, the direction of the protrusion parallel with the side wall of the backplane is the length direction, and the direction of the protrusion perpendicular to the side wall of the backplane is the width direction.

Advantages of the invention are summarized below: the protrusions for assistantly supporting the LCD panel are additionally arranged on the LCD device of the invention; the protrusion(s) is arranged between two member units when the distance between two adjacent member units is long; and the support surface of the protrusion is flush with the support surface of the middle frame to provide intermediate support force, so as to enable the support force obtained by the LCD panel is more uniform, and prevent excessive local stress.

### BRIEF DESCRIPTION OF FIGURES

FIG. 1 is a structure diagram of an LCD device of a first example of the invention;

FIG. 2 is an enlarged view of A shown in FIG. 1;

FIG. 3 is a structure diagram of an LCD device of a second example of the invention; and

FIG. 4 is an enlarged view of B shown in FIG. 3.

Legends: 1. middle frame; 11. frame corner member; 12. frame edge member; 13. support surface; 2. backplane; 21. bottom plate; 3. LCD panel; 4. protrusion; 41. support surface.

### DETAILED DESCRIPTION

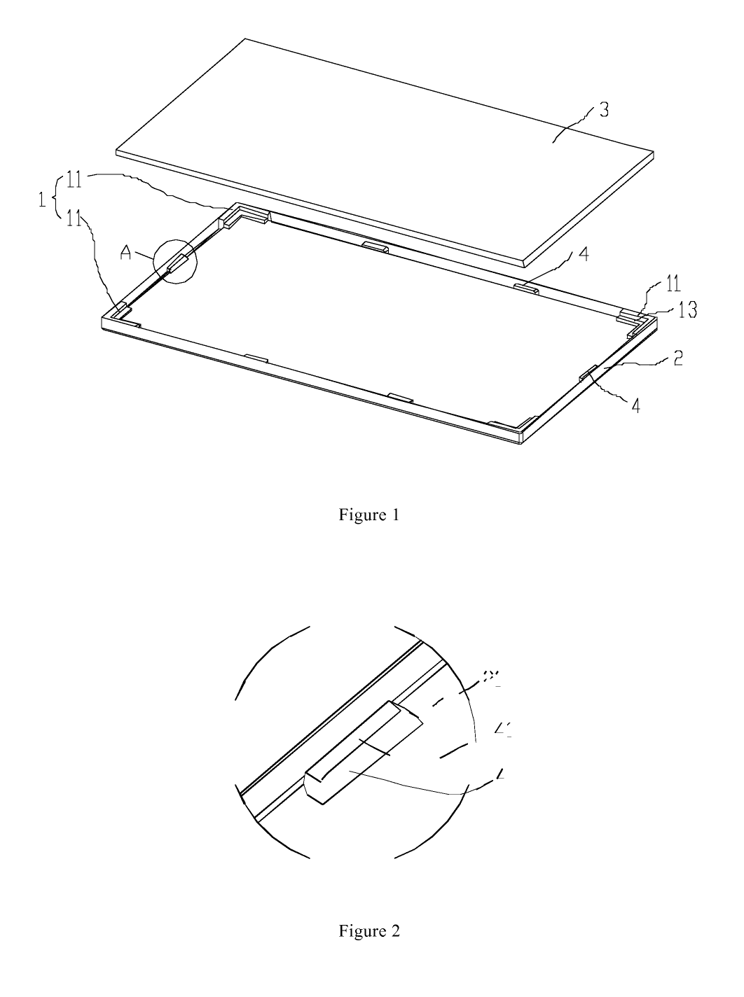

The invention provides an LCD device, comprising a backlight module; the backlight module comprises a middle frame 1, and a backplane 2. FIG. 1 and FIG. 2 show a first example of the LCD device. The LCD device comprises a middle frame 1, a backplane 2, and an LCD panel 3; the LCD panel 3 is arranged on a support surface 13 of the middle frame 1; the middle frame 1 comprises a plurality of member units, and a distance is reserved between two adjacent member units. A bottom plate 21 of the backplane 2 is further provided with protrusion(s) 4 used for assistantly supporting the LCD panel 3; the protrusion(s) comprises a support surface 41; the support surface of the protrusion 4 is flush with the support surface 13 of the middle frame.

The protrusions 4 for assistantly supporting the LCD panel 3 are additionally arranged on the LCD device of the invention; the protrusions 4 are arranged between two member units when the distance between two adjacent member units is long; the support surface of each protrusion 4 is flush with the support surface 13 of the middle frame to provide intermediate support force, so as to enable the support force obtained by the LCD panel 3 is more uniform, and prevent excessive local stress.

In the example, the backplane 2 is locally punched to form the protrusion 4. The side walls of the protrusion 4 are of a closed structure, and the support surface 41 of the protrusion 4 is a plane. The plane can better provide support for the LCD panel 3, to avoid the adverse effect of point contact and line contact on the LCD panel 3. The protrusion 4 does not add the material cost. The protrusion 4 with side walls of a closed structure has high strength, and can provide higher support force. The member units are four frame corner members 11, and are distributed on the four corners of the backplane 2. A distance is reserved between every two frame corner members 11. The distance of the middle frame 1 in the length direction is more than that in the width direction. In the example, the frame corner members 11 can be fixed on the backplane 2 by screws, fasteners, etc. The backplane 2 is provided with a plurality of protrusions 4 in the length direction, and is provided with one protrusion 4 in the width direction. The length or the total length of the protrusions 4 arranged between adjacent member units is less than the distance between adjacent member units; thus, the protrusions 4 are successfully arranged on a bottom plate 22 of the backplane. The width of the support surface of the protrusion 4 is less than or equal to that of the support surface 13 of the middle frame, to avoid blocking out the light emitted by the backlight module.

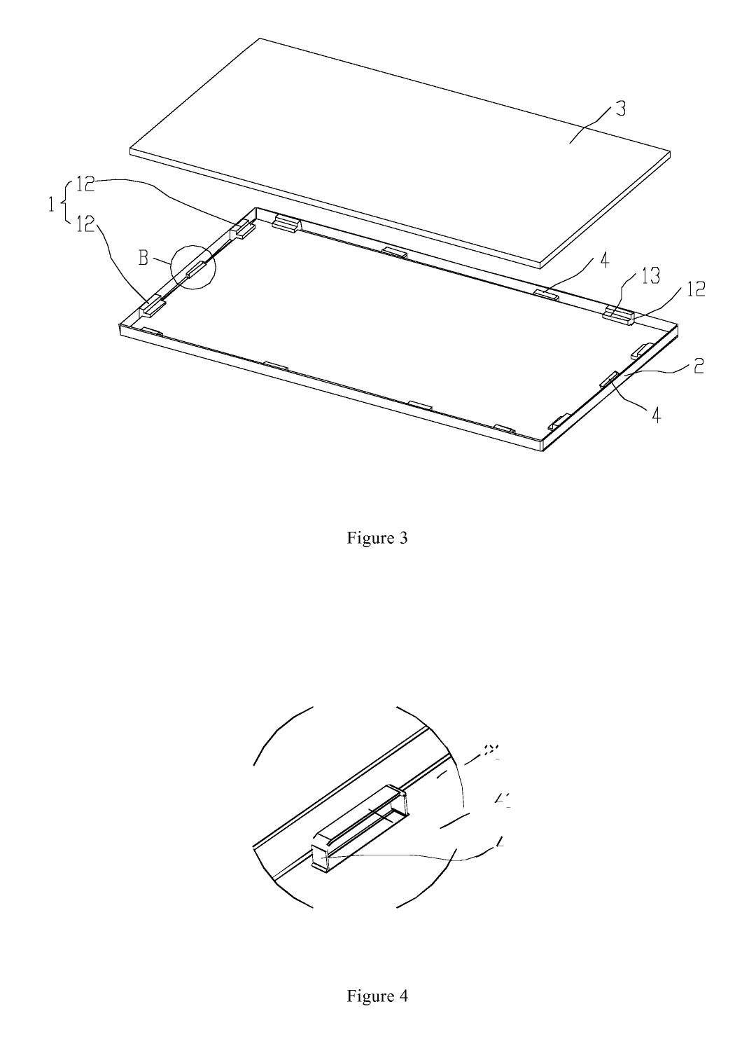

FIG. 3 and FIG. 4 show a second example of the LCD device of the invention, and the second example is different from the first example in that: the member units are frame edge members 12, and are distributed on the four edges of the backplane 2; the backplane 2 is locally punched to form the protrusion 4. Partial side walls of the protrusion 4 are of an open structure, and the protrusion 4 is in a bent bar shape. The protrusion 4 does not add the material cost, and the protrusion 4 with side walls of an open structure has slightly low strength. However, the height of the protrusion 4 can be designed to be high. When the ductibility of the material of the backplane is slightly low, and the maximum height of the protrusion 4 with side walls of a closed structure is still not high enough to be flush with the support surface of the middle frame, under the condition of ensuring that the material does not fracture, the scheme can be employed. In the example, the frame edge members can be fixed on the backplane by screws, fasteners, etc. Alternatively, fixing columns can be arranged on the frame edge members, and fixing holes can be arranged in the side walls of the backplane. The fixing columns of the frame edge members are inserted in the fixing holes of the backplane; thus, the frame edge members are fixed on the backplane.

In the example, the protrusions 4 can be arranged on the four corners of the backplane 2, to support the four corners of the LCD panel 3.

In the invention, both the number and length of the protrusions can be purposefully set in accordance with the distance between two adjacent member units. When the distance between two adjacent member units is long, a plurality of protrusions are arranged; and when the distance between two adjacent member units is short, only one protrusion is arranged, or no protrusion is arranged.

In the invention, the member units can be frame corner members and frame edge members; the frame corner members are distributed on the four corners of the backplane, and the frame edge members are distributed on the four edges of the backplane. When the distance between the frame edge members or the distance between the frame edge member and the frame corner member is long, protrusions can be appropriately arranged, to provide assistant support force for the LCD panel.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD device, comprising: a middle frame, a backplane, and an LCD panel; wherein said LCD panel is arranged on a support surface of said middle frame; said middle frame comprises a plurality of member units, and a distance is reserved between two adjacent member units; a bottom plate of said LCD device is provided with protrusion(s) for assistantly supporting said LCD panel; said protrusion comprises a support surface, and the support surface of said protrusion is flush with the support surface of said middle frame; said backplane is locally punched to form said protrusion; partial side walls of said protrusion are of an open structure, said protrusion is in a bent bar shape, the support surface of said protrusion is a plane, and the width of the support surface of said protrusion is less than or equal to that of the support surface of said middle frame; said member units are frame corner members, and are distributed on the four corners of said backplane; the number of said protrusions arranged between part of adjacent member units is multiple.

2. An LCD device, comprising: a middle frame, a backplane, and an LCD panel; wherein said LCD panel is arranged on a support surface of said middle frame; said middle frame comprises a plurality of member units, and a distance is reserved between two adjacent member units; a bottom plate of said backplane is provided with protrusion(s) used for assistantly supporting said LCD panel; said protrusion comprises a support surface; the support surface of said protrusion is flush with the support surface of said middle frame.

3. The LCD device of claim 2, wherein said backplane is locally punched to form said protrusion; the side walls of said protrusion are of a closed structure.

4. The LCD device of claim 2, wherein said backplane is locally punched to form said protrusion; partial side walls of said protrusion are of an open structure, and said protrusion is in a bent bar shape.

5. The LCD device of claim 3, wherein the support surface of said protrusion is a plane.

6. The LCD device of claim 2, wherein the width of the support surface of said protrusion is less than or equal to that of the support surface of said middle frame.

7. The LCD device of claim 2, wherein said member units are frame corner members, and are distributed on the four corners of said backplane.

8. The LCD device of claim 2, wherein said member units are frame edge members, and are distributed on the four edges of said backplane.

9. The LCD device of claim 2, wherein said member units are frame corner members and frame edge members; said frame corner members are distributed on the four corners of said backplane, and said frame edge members are distributed on the four edges of said backplane.

10. The LCD device of claim 2, wherein the number of said protrusions arranged between part of adjacent member units is multiple.

11. A backlight module, comprising: a middle frame, and a backplane; wherein said middle frame is provided with a support surface used for supporting said LCD panel; said middle frame comprises a plurality of member units, and a distance is reserved between two adjacent member units; a bottom plate of said backplane is provided with protrusion(s) used for assistantly supporting said LCD panel; said protrusion comprises a support surface; the support surface of said protrusion is flush with the support surface of said middle frame.

12. The backlight module of claim 11, wherein said backplane is locally punched to form said protrusion; the side walls of said protrusion are of a closed structure.

13. The backlight module of claim 11, wherein said backplane is locally punched to form said protrusion; partial side walls of said protrusion are of an open structure, and said protrusion is in a bent bar shape.

14. The backlight module of claim 12, wherein the support surface of said protrusion is a plane.

15. The backlight module of claim 11, wherein the width of the support surface of said protrusion is less than or equal to that of the support surface of said middle frame.

16. The backlight module of claim 11, wherein said member units are frame corner members, and are distributed on the four corners of said backplane.

17. The backlight module of claim 11, wherein said member units are frame edge members, and are distributed on the four edges of said backplane.

18. The backlight module of claim 11, wherein said member units are frame corner members and frame edge members; said frame corner members are distributed on the four corners of said backplane, and said frame edge members are distributed on the four edges of said backplane.

19. The backlight module of claim 11, wherein the number of said protrusions arranged between part of adjacent member units is multiple.
